(19) United States
(12) Patent Application Publication
(10) Pub. No.: US 2022/0366242 A1
(43) Pub. Date: Nov. 17, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Takamasa Tsunoda, Tokyo (JP)

(21) Appl. No.: 17/735,342

(22) Filed: May 3, 2022

(30) Foreign Application Priority Data
May 14, 2021 (JP) 2021-082595

(51) Int. Cl. G06N 3/08; G06N 3/04; G06V 10/82; G06V 10/77; G06V 10/776

(52) U.S. Cl. CPC G06N 3/08; G06N 3/04; G06V 10/82; G06V 10/7715; G06V 10/776

(57) ABSTRACT

An information processing apparatus is operable to train a machine learning model that has a hierarchical structure configured by a plurality of hierarchical layers and that is used for recognizing a recognition target in inputted data. An obtaining unit obtains input data and data indicating a ground truth of an output from the machine learning model regarding the input data. A learning unit trains the machine learning model based on an error between the data indicating the ground truth of the output from the machine learning model regarding a specific domain of the input data and at least one output in an intermediate layer of the machine learning model with respect to the input data.

### BACKGROUND OF THE INVENTION

### Field of the Invention

The present invention relates to an information processing apparatus, an information processing method, and a storage medium.

### Description of the Related Art

In tasks of pattern recognition (such as image classification, object detection, or semantic segmentation) that uses a CNN, a data set for evaluation (evaluation data), which is for evaluating the accuracy of final recognition, and a data set for verification (verification data), which is for evaluating the accuracy of recognition in the current progression of training, are prepared. In these tasks, an appropriate evaluation index is set for each task. Then, for the entire data set or for each class (subset) to be focused on, the performance of the CNN is evaluated by evaluating the accuracy of recognition using the set evaluation index.

Japanese Patent Laid-Open No. 2019-106119 discloses a technique for obtaining an identifier that matches a user's objective by quantitatively evaluating targets, for which the accuracy of identification increases when additional training is performed, and other targets. Also, Japanese Patent Laid-Open No. 2019-109924 discloses a technique for improving the accuracy of classification of a supervised image classifier by extracting, using an unsupervised image classifier, an image that is similar to an image for verification for which the accuracy of recognition was poor.

### SUMMARY OF THE INVENTION

According to one embodiment of the present disclosure, an information processing apparatus operable to train a machine learning model that has a hierarchical structure configured by a plurality of hierarchical layers and that is used for recognizing a recognition target in inputted data, the apparatus comprises: an obtaining unit configured to obtain input data and data indicating a ground truth of an output from the machine learning model regarding the input data; and a learning unit configured to train the machine learning model based on an error between the data indicating the ground truth of the output from the machine learning model regarding a specific domain of the input data and at least one output in an intermediate layer of the machine learning model with respect to the input data.

According to another embodiment of the present disclosure, an information processing apparatus operable to train a machine learning model that has a hierarchical structure configured by a plurality of hierarchical layers and that is used for recognizing a recognition target in inputted data, the apparatus comprises: a recognition unit configured to recognize the recognition target in input data using a machine learning model having a hierarchical structure configured by a plurality of layers; a presentation unit configured to present a result of recognition by the recognition unit with respect to input data for verification; an obtaining unit configured to obtain information indicating a specific domain for which a recognition result needs to be improved in the input data for verification; and a learning unit configured to perform training so as to optimize the machine learning model using data indicating a ground truth of an output from the machine learning model with respect to input data for training extracted regarding the specific domain.

According to yet another embodiment of the present disclosure, an information processing method performed by an information processing apparatus operable to train a machine learning model that has a hierarchical structure configured by a plurality of hierarchical layers and that is used for recognizing a recognition target in inputted data, the method comprises: obtain input data and data indicating a ground truth of an output from the machine learning model regarding the input data; and train the machine learning model based on an error between the data indicating the ground truth of the output from the machine learning model regarding a specific domain of the input data and at least one output in an intermediate layer of the machine learning model with respect to the input data.

According to still another embodiment of the present disclosure, an information processing method performed by an information processing apparatus operable to train a machine learning model that has a hierarchical structure configured by a plurality of hierarchical layers and that is used for recognizing a recognition target in inputted data, the method comprises: recognize the recognition target in input data using a machine learning model having a hierarchical structure configured by a plurality of layers; present a result of recognition with respect to input data for verification; obtain information indicating a specific domain for which a recognition result needs to be improved in the input data for verification; and perform training so as to optimize the machine learning model using data indicating a ground truth of an output from the machine learning model with respect to input data for training extracted regarding the specific domain.

According to yet still another embodiment of the present disclosure, a non-transitory computer readable storage medium on which is stored a computer program for making a computer execute an information processing method for an information processing apparatus operable to train a machine learning model that has a hierarchical structure configured by a plurality of hierarchical layers and that is used for recognizing a recognition target in inputted data, the method comprises: obtain input data and data indicating a ground truth of an output from the machine learning model regarding the input data; and train the machine learning model based on an error between the data indicating the ground truth of the output from the machine learning model regarding a specific domain of the input data and at least one output in an intermediate layer of the machine learning model with respect to the input data.

Further features of the present invention will become apparent from the following description of exemplary embodiments (with reference to the attached drawings).

### BRIEF DESCRIPTION OF THE DRAWINGS

FIGS. 1A to 1C are diagrams for explaining an example of an input image, a GT, and image recognition processing according to a first embodiment.

FIG. 2 is a diagram for explaining an example of a learning mechanism of a CNN according to the first embodiment.

FIG. 3A is a diagram illustrating an example of a functional configuration of a recognition apparatus according to the first embodiment.

FIG. 3B is a diagram illustrating an example of a functional configuration of a learning apparatus according to the first embodiment.

FIG. 4A is a flowchart for explaining an example of processing by the recognition apparatus according to the first embodiment.

FIGS. 4B, 4C, and 4D are flowcharts for explaining examples of processing by training processing.

FIGS. 5A, 5B, and 5C are diagrams illustrating examples of a response, a GT, and a specific domain GT of a specific domain model according to the first embodiment.

FIGS. 6A and 6B are diagrams illustrating examples of a verification image and an inference result according to the first embodiment.

FIG. 6C is a diagram for explaining an example of extraction of a specific domain from the inference result according to the first embodiment.

FIG. 7 is a diagram illustrating an example of a functional configuration of the learning apparatus according to a second embodiment.

FIGS. 8A, 8B, 8C, 8D, 8E, 8F, 8G, and 8H are diagrams illustrating examples of a response, a corresponding GT, and a specific domain GT of each specific domain model according to the second embodiment.

FIG. 8I is a diagram for explaining processing using a plurality of channels according to the second embodiment.

FIG. 9 is a diagram illustrating an example of a functional configuration of the learning apparatus according to a third embodiment.

FIG. 10 is a diagram for explaining an example of assignment processing according to the third embodiment.

FIG. 11 is a diagram for explaining an example of reinforcement learning according to the third embodiment.

FIG. 12 is a diagram illustrating a hardware configuration of a computer according to a fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In the CNN described above, even if an overall recognition accuracy from evaluation data or verification data is sufficient, the recognition accuracy may be insufficient for a small number of specific cases. In the technique described in Japanese Patent Laid-Open No. 2019-106119, since extraction of a case to be improved and additional training so as to directly improve it are not performed, it is unknown whether a model that matches the user's objective could be obtained by that additional training. In addition, in the technique described in Japanese Patent Laid-Open No. 2019-109924, since a similar image is extracted based on the similarity of feature amounts of the entire image, when a local region in an image is the issue, it is difficult to improve the recognition accuracy even if additional training is performed.

The purpose of embodiments of the present invention is to provide an information processing apparatus that efficiently improves the recognition accuracy for a specific case for a machine learning model that performs a recognition task.

### FIRST EMBODIMENT

A recognition apparatus and a learning apparatus, which serve as information processing apparatuses according to a first embodiment, recognize a recognition target in inputted data using a machine learning model. In the present embodiment, image recognition processing by semantic segmentation using a convolutional neural network (CNN), which takes an image as input data, is performed. Here, the machine learning model is trained by the learning apparatus, and the recognition processing is performed by the recognition apparatus using the training result, but the recognition apparatus and the learning apparatus may be implemented in the same apparatus or separate apparatuses.

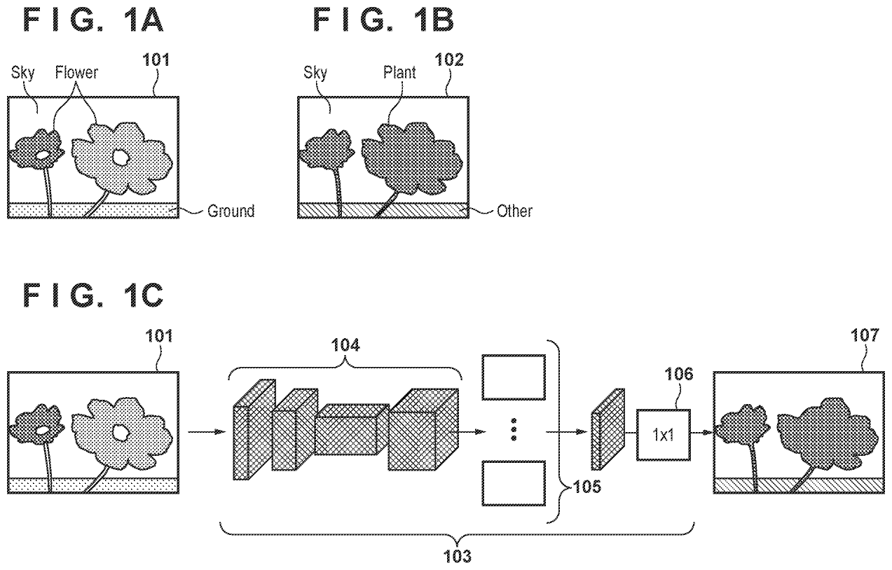

FIGS. 1A to 1C are schematic diagrams for explaining the image recognition processing performed by the recognition apparatus. An input image 101 illustrated in FIG. 1A is an example of image data that is to be inputted to the recognition apparatus according to the present embodiment. Here, it is assumed that the input image 101 is an RGB image, but the format of a color space or the like is not particularly limited and may be, for example, a CMYK format or the like so long as the image recognition processing can be performed.

Further, in the recognition processing performed by the recognition apparatus and the learning apparatus according to the present embodiment, subjects in an image are classified into the categories Plant, Sky, or Other. Here, in the input image 101, flowers (classified as Plant) are disposed in the center of the foreground, and the sky (classified as Sky) and the ground (classified as Other) are disposed in the background. These are only examples, and classification into different categories may be performed by the recognition apparatus and the learning apparatus, and the subjects that are disposed in the input image 101 and a ground truth (GT) 102, which will be described later, may also be different.

The GT 102 illustrated in FIG. 1B is an example of a ground truth (GT) corresponding to the input image 101. As described above, in the present embodiment, it is assumed that flowers correspond to the category of Plant, the sky to the category of Sky, and the ground to the category of Other. Also, as illustrated in FIG. 1B, it is assumed that, in the GT 102, labels corresponding to the respective categories are assigned to regions in which objects of those categories are present. A label is information indicating a category to be assigned to a region, and in each figure, labels that are to be assigned as a result of classification (or are assigned to ground truth data) are indicated by color (mesh pattern). In the present embodiment, an image recognition task in which a region in the input image is divided into sub-regions by specific category, such as in the GT 102, is performed as semantic segmentation.

FIG. 1 C illustrates an example of input/output by a CNN 103 provided in the recognition apparatus according to the present embodiment. Description will be given below for a mechanism of calculation in the CNN 103 according to the present embodiment. Jonathan Long, Evan Shelhamer, Trevor Darrell, “ Fully Convolutional Networks for Semantic Segmentation” CVPR 2015, 2014 and Olaf Ronneberger, Philipp Fischer, Thomas Brox, “U-net: Convolutional Networks for Biomedical Image Segmentation” MICCA 2015, 2015 describe examples of neural networks that perform semantic segmentation.

The CNN 103 has a hierarchical structure in which a plurality of modules composed of layers for performing convolution, activation, pooling, normalization, and the like are connected and, taking the input image 101 as input, outputs an inference result 107, which is a result of category classification in an image. As described in Jonathan Long, et al. and Olaf Ronneberger, et al., the CNN 103 adjusts the size of the intermediate features from a lower-order layer to a higher-order layer by upsampling the intermediate features of a higher-order layer in accordance with the output size and utilizes 1×1 convolution to thereby be able to output the inference result 107. Here, the CNN 103 has feature extraction layers 104.

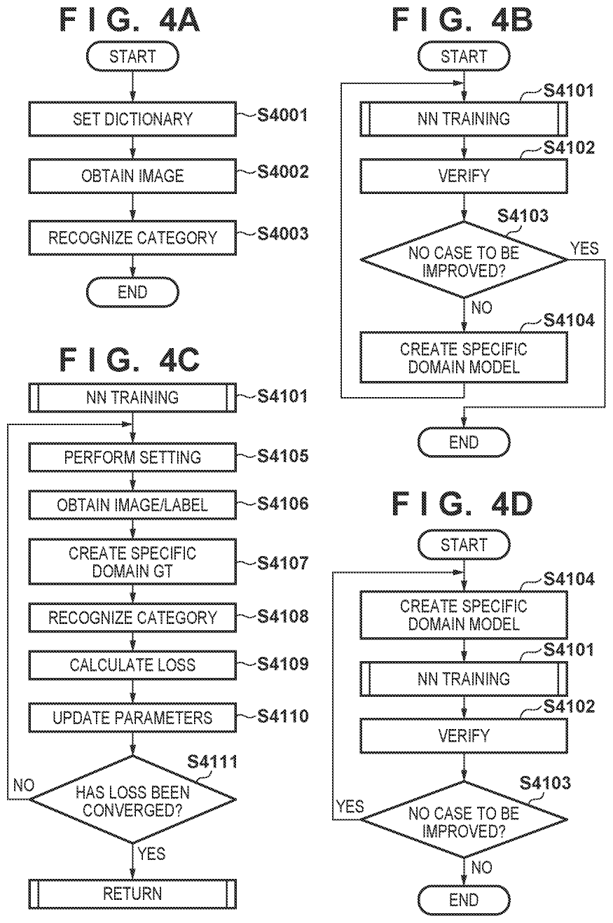

An intermediate layer 105 is an example of an intermediate layer in the CNN 103. The recognition apparatus, which serves as an information processing apparatus according to the present embodiment, adds an activation layer to any channel of the intermediate layer 105. Meanwhile, a specific domain GT (details will be described later), which is a GT for the output of this activation layer, is obtained. The recognition apparatus can then calculate the loss between the output and the GT of the activation layer and train the CNN so that the output of the intermediate layer 105 corresponds to the specific domain GT. Here, it is assumed that verification data indicating a case to be improved (referred to as a case that needs improvement) for which the recognition accuracy is unsatisfactory is selected by the user, and training is performed such that an output of one channel of the intermediate layer 105 responds to this case. This training processing will be described later with reference to FIGS. 4A to 4D. A case that needs improvement is verification data indicating a verification result that is selected by the user based on a verification result for which verification data stored in the verification storage unit 3102, which will be described later, has been used and that is deemed unsatisfactory by the user. Verification data is a data group prepared in advance for verification of the progress of the current training, that is, evaluation of recognition accuracy, and includes image data for input and data indicating a ground truth for recognition processing with respect to that image data. Although it is assumed that the intermediate layer 105 has multiple channels of the same resolution as the input via upsampling, the resolution may be different from the input image.

The output layer 106 outputs the inference result 107 via a 1×1 convolution and an activation layer. Here, it is assumed that the inference result 107 is the same in height and width to the input image 101 and has three normalized channels corresponding to the likelihood of Plant, Sky, and Other categories, respectively. That is, in these three channels, it is assumed that the sum of the likelihood of Plant, Sky, and Other categories at the same location is 1.0, and each value is a real number in [0, 1]. A softmax function may be used in the final activation layer of the output layer 106. As an activation layer of the CNN 103, any activation layer normally used in a network configuration of a CNN is can be used, and for example, ReLU (Rectified Linear Unit, ramp function), or Leaky ReLU, or the like may be used.

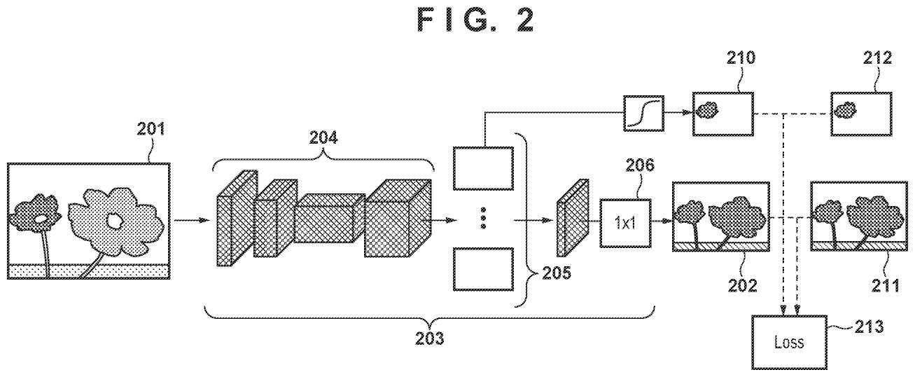

FIG. 2 is a schematic diagram for explaining a learning mechanism in a learning apparatus serving as an information processing apparatus according to the present embodiment. An input image 201 is an image that is similar to the input image 101 and is inputted to a CNN 203. The CNN 203 is a CNN having the same configuration as the CNN 103 and includes feature extraction layers 204, an intermediate layer 205, and an output layer 206.

An output 202 is an example of an output result of the CNN 203 and, similarly to the inference result 107 of FIG. 1C, is a result of category classification for the input image 201. Similarly to the GT 102 of FIG. 1B, a GT 211 is ground truth data corresponding to the input image. An output 210 is an example of an output of an intermediate layer via a predetermined activation layer for a response for one channel (one category) of the intermediate layer 205. The output 210 is an output of a channel that has been trained to respond to a case that needs improvement, and a GT 212 is a GT for a region to be improved in recognition accuracy. For the output 202 and the output 210, the learning apparatus calculates a loss 213 with the ground truth data (GT 211 and GT 212, respectively). Here, the loss 213 is calculated using cross entropy.

In a single instance of update processing at the time of training, backward propagation of error is performed based on the loss calculated by a loss function, the update values of the weights and biases of each layer are calculated, and an update is performed. In this example, by obtaining the GT 212 for the response for one channel of the intermediate layer 205 and calculating the loss, the training for one channel of the intermediate layer is performed. This training processing is not limited to one channel, and GTs corresponding to a plurality of channels of the intermediate layer 105 may be prepared and training may be performed therewith. Here, a channel of the intermediate layer 205 used for training is selected from all the channels of the intermediate layer 205. The channel selected here may be prepared in advance for training, randomly selected from all the channels, or selected based on a contribution of channels to the final output 210 (this example will be described later with reference to a second embodiment) or the like.

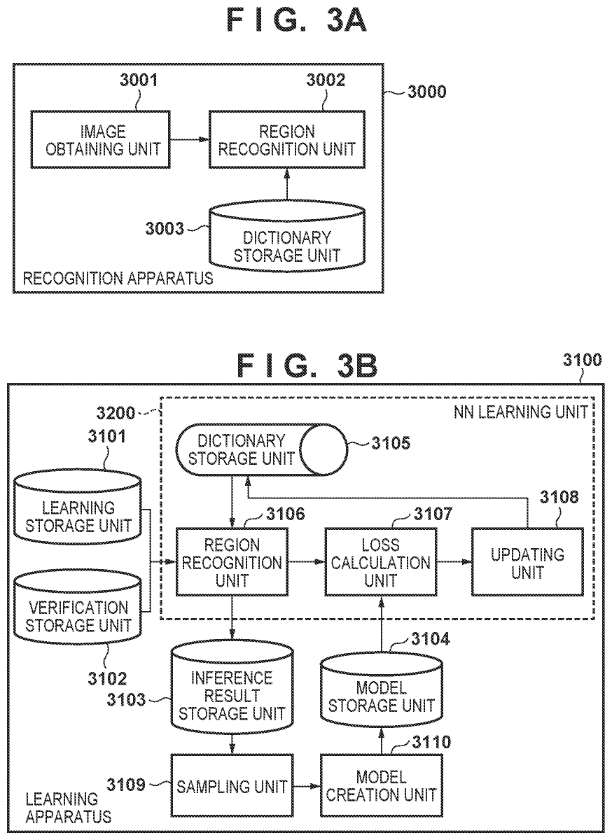

FIG. 3A is a block diagram illustrating an example of a functional configuration of the recognition apparatus serving as an information processing apparatus according to the present embodiment. A recognition apparatus 3000 performs processing during the runtime of the above-described CNN 103 and, to do so, includes an image obtaining unit 3001, a region recognition unit 3002, and a dictionary storage unit 3003. The functions of each block will be described in the flowcharts of FIGS. 4A to 4D.

FIG. 3B is a block diagram illustrating an example of a functional configuration of the learning apparatus serving as an information processing apparatus according to the present embodiment. A learning apparatus 3100 performs processing in the learning mechanism illustrated in FIG. 2. The learning apparatus 3100 includes a learning storage unit 3101, a verification storage unit 3102, an inference result storage unit 3103, and a model storage unit 3104 as storage units for storing each piece of data. The learning apparatus 3100 includes an NN learning unit 3200 including a dictionary storage unit 3105, a region recognition unit 3106, a loss calculation unit 3107, and an updating unit 3108. Further, the learning apparatus 3100 includes a sampling unit 3109 and a model creation unit 3110 and creates a specific domain model, which is a model for extracting, from the input data, a domain region for which a recognition result needs to be improved in accordance with a case that needs improvement.

FIGS. 4A to 4D are flowcharts for explaining examples of processing performed by the recognition apparatus 3000 and the learning apparatus 3100 according to the present embodiment. FIG. 4A indicates an example of processing performed by the recognition apparatus 3000 during the runtime of the CNN 103 described above. In step S4001, the dictionary storage unit 3003 sets a dictionary to be used by the region recognition unit 3002. Here, description will be given below assuming that the dictionary describes parameters such as weights and biases used in each layer of the CNN. That is, in step S4001, the weights and biases of each layer of the convolutional neural network to be used by the region recognition unit 3002 are loaded.

In step S4002, the image obtaining unit 3001 obtains an image (that is, an input image 101) for which recognition processing is to be performed. The image obtaining unit 3001 resizes the input image 101 to match the input size of the CNN 103 and performs preprocessing of each pixel as required. For example, as preprocessing of each pixel, the image obtaining unit 3001 may perform processing for subtracting, from an RGB channel of each pixel of the input image, an average RGB value of a certain image set obtained in advance and may perform any processing depending on the environment. Hereinafter, description will be given assuming that the image data converted by such preprocessing is also referred to as an input image.

In step S4003, the region recognition unit 3002 recognizes a recognition target in the input data by using a machine learning model having a hierarchical structure configured by a plurality of hierarchical layers. In the present embodiment, the region recognition unit 3002 recognizes the category of each pixel of the input image. That is, the process in step S4003 is the process of forward propagation by the CNN 103, and a response by the feature extraction layers 104 and the intermediate layer 105 is outputted. As described above, the CNN 103 is trained so as to optimize at least one output of the intermediate layer of the machine learning model for input data using the ground truth data for the recognition of the input data for training, which has been extracted for a specific domain. In the present embodiment, training is performed such that the output of one channel of the intermediate layer 105 responds to a case that needs improvement. Training using a case that needs improvement will be described later with reference to FIG. 4C. The region recognition unit 3002 calculates an inference result (here, the inference result 107) of the semantic segmentation by the output layer 106 configured by the 1×1 convolution layer and the activation layer. As described above, this inference result is a tensor that has the same size (height and width) as the input image and a number of channels proportional to the number of categories, and each element is a real number normalized to [0, 1]. The above is the processing during runtime.

Next, the processing during training will be described with reference to the flowchart of FIG. 4B. The processing in steps S4101 to S4104 of FIG. 4B is loop processing that is repeated in the learning apparatus 3100 until it is determined that there are no cases to be improved.

In step S4101, the NN learning unit 3200 trains the CNN 203. The processing in step S4101 will be described in detail with reference to FIG. 4C.

FIG. 4C is a flowchart for explaining an example of detailed content of the training processing of the CNN performed in step S4101 and includes the processing in steps S4105 to S4110. In step S4105, the dictionary storage unit 3105 sets initial values of hyperparameters related to training including initial values of the dictionary of the CNN 203. The parameters set here are parameters used in common CNNs, such as, for example, a mini batch size, learning coefficients, and parameters of a solver of a stochastic gradient descent; detailed description on the setting processing will be omitted.

Further, in step S4105 of step S4101 in the second and subsequent loop processing of FIG. 4B, some or all of the parameters set in step S4105 of the previous loop may be inherited. In this case, the weights and biases of each layer of the CNN are not set to initial values, and the weights and biases, which are the previous training results, stored in the dictionary storage unit 3105, are read and used.

Steps S4106 to S4111 are training iteration processing, which is performed until the loss has sufficiently converged. Here, similarly to general training processing, it is assumed that iterative processing is performed until the value of the calculated loss becomes a predetermined value or less.

In step S4106, the image obtaining unit 3001 obtains the input data and data indicating a ground truth for classification regarding the input data. For example, the image obtaining unit 3001 obtains images for training and corresponding GTs (labels) proportional to the mini batch size. Here, the learning storage unit 3101 stores the images for training and the corresponding GTs, and the image obtaining unit 3001 reads and obtains them. For each image, the image obtaining unit 3001 may perform preprocessing such as padding processing, which is random clipping, color conversion, or the like, or normalization.

In step S4107, the loss calculation unit 3107 creates a specific domain GT, which is data indicating a ground truth for classification regarding a specific domain of the input data.

Here, the loss calculation unit 3107 can extract a specific domain region from the input data. At this time, the loss calculation unit 3107 may use a specific domain model, which is a model for extracting a specific domain region. The specific domain model is a model for extracting a region having a specific domain, which is created in step S4104 to be described below, based on a case that needs improvement; detailed explanation of the creation processing will be described later with reference to FIG. 6. Here, a specific domain is, for example, a portion having a specific color, a portion having a specific spatial frequency, or a portion of a subject of a specific class (category) in the input data and may be a region having a predetermined feature amount. In the present embodiment, description will be given assuming that a portion having a specific color is used as a specific domain.

Further, the loss calculation unit 3107 can create data (a specific domain GT) that indicates a ground truth for classification regarding a specific domain of input data from data (GT) that indicates a ground truth for classification regarding input data in a specific domain region.

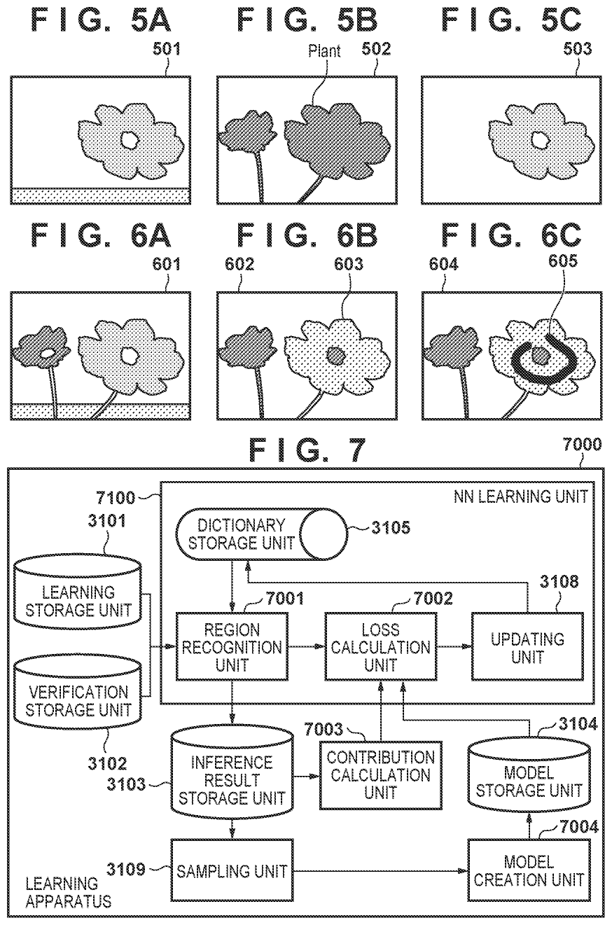

Here, the creation of a specific domain GT will be described with reference to FIGS. 5A to 5C. FIGS. 5A to 5C are schematic diagrams for explaining a specific domain GT. A response 501 is a response of a specific domain model created in an HSV color space for the image obtained in step S4106. In the example of FIG. 5A, regions having specific hues and saturation corresponding to a specific domain model with respect to the input image correspond to regions of the mesh pattern. A Plant GT 502 is ground truth data corresponding to Plant regions of an image. Also, a specific domain GT 503 illustrated in FIG. 5C is a two-dimensional array obtained by multiplying the response 501 and the Plant GT 502 for each element of a pixel. As described above, the specific domain GT 503 is a GT that indicates, for a specific domain region, a region that is a Plant region. As described above, the loss calculation unit 3107 can create a specific domain GT from ground truth data (e.g., Plant GT) that indicates whether each element of the input data in a specific domain region (e.g., Plant region) belongs to a specific class.

In the present embodiment, description will be given assuming that the elements of the response 501, the Plant GT 502, and the specific domain GT 503 are each normalized to a real number of [0, 1]. The specific domain GT 503 thus obtained is used as a GT corresponding to the response of one channel of the intermediate layer 205 of the CNN 203.

In step S4108, the region recognition unit 3106 recognizes the category of an image in the mini batch by the forward propagation processing of the CNN 203. Since this processing is performed in the same manner as the processing in step S4003, redundant description will be omitted.

In step S4109, the loss calculation unit 3107 calculates the loss based on a predetermined loss function from the output of the forward propagation that is the target of the training of the CNN 203 and the GT corresponding thereto. The loss calculation unit 3107 uses, as the outputs of the forward propagation, the output 210 (hereinafter, referred to as “response” as appropriate) of one channel of the intermediate layer 205 and the output 202 of the final network. The GT corresponding to the output 210 is a specific domain GT 503, and the GT corresponding to the output 202 is the GT 102 of each category. The output 202 is the output of three channels corresponding to Plant, Sky, and Other, and a GT of each category corresponding to this is also data of three channels. The number of channels of the specific domain GT 503 is 1, which is the same as the output 210. In the present embodiment, the loss calculation unit 3107 calculates a cross entropy loss with respect to a specific domain GT and each GT of each category from these output/GT pairs and adds the calculated two cross entropy losses with appropriate weighting. The rate of improvement of the case that needs improvement can be increased by increasing the weighting of the specific domain GT, but it is assumed that the user can arbitrarily set this weight.

As described above, the loss calculation unit 3107 can evaluate the error (loss) between the data (specific domain GT) indicating the ground truth for the classification regarding a specific domain of the input data and at least one output (output 210) of the intermediate layer of the machine learning model with respect to the input data. In addition to this, the loss calculation unit 3107 can evaluate the error (loss) between the data (GT) indicating the ground truth for the classification regarding the input data and the output of the machine learning model (output 202) for the input data. The updating unit 3108, which will be described later, can perform training of the machine learning model based on both of these errors.

In step S4110, the updating unit 3108 updates the parameters of the CNN. In the present embodiment, the updating unit 3108 calculates the weights and biases of each layer of the CNN by backward propagation of errors for the total loss calculated in step S4109 and updates each of them. The values of the updated weights and biases are stored in the dictionary storage unit 3105.

In step S4111, the updating unit 3108 determines whether the loss calculated in step S4109 has sufficiently converged. Here, the threshold used in the determination is set in advance as desired, and it is assumed that determination of whether the loss is a threshold or less is made. If it is determined that the loss has sufficiently converged, loop processing is ended, and the processing proceeds to step S4102; otherwise, the processing returns to step S4105.

The end timing of the loop to be determined in step S4111 is not limited to when the value of the loss is the predetermined threshold or less. For example, the above-described iterative processing may end at a predetermined number of epochs of training data, when a predetermined number of iterations has been completed, or when a predetermined time has elapsed and transition to the verification processing of step S4102.

According to such processing illustrated in FIG. 4C, the parameters of each layer of the CNN are updated based on a GT containing a specific domain GT.

Then, the verification processing of step S4102 is performed using the updated CNN. In step S4102, the NN learning unit 3200 recognizes the recognition target in the input data for verification by using the machine learning model. Here, the NN learning unit 3200 evaluates, using the verification data stored in the verification storage unit 3102, the accuracy of the CNN model that has been trained in step S4101 and stores the evaluation result in the inference result storage unit 3103. The evaluation of accuracy of the CNN model may be performed using the cross entropy loss used during training and may be performed using another known index, such as a Pixel Accuracy. Here, the inference result storage unit 3103 stores the inference result of three categories of Plant, Sky, and Other, which is the final output of the network, and the GT corresponding thereto. Furthermore, the inference result storage unit 3103 may appropriately store those that are useful for analyzing the result, such as other outputs of the intermediate layer.

In step S4103, the sampling unit 3109 determines whether or not there is a case that needs improvement selected by the user in the verification data. When there are no cases that need improvement, the processing ends, and when there is a case that needs improvement, the processing advances to step S4104.

Specifically, the sampling unit 3109 can present the inference result for the verification data, which is stored in the inference result storage unit 3103, to the user via a display unit (not illustrated). The sampling unit 3109 may present the image data or the ground truth data included in the verification data to the user. In this case, the user can select, via an input unit (not illustrated), verification data whose inference result is unsatisfactory as a case that needs improvement.

In step S4104, the model creation unit 3110 performs a specification obtaining operation for obtaining information (for example, a specific domain model) indicating a specific domain in which it is required to improve the recognition result in the input data for verification. According to the information indicating the specific domain thus obtained, the NN learning unit 3200 can perform additional training for the machine learning model as described above.

In the following, description will be given for a case in which the model creation unit 3110 creates a specific domain model from a case that needs improvement. FIGS. 6A to 6C are schematic diagrams for explaining the processing of creating a specific domain model. In this embodiment, description will be given for a case of focusing on Plant among the categories of Plant, Sky, and Other when creating a specific domain model.

First, the model creation unit 3110 can obtain the data of a region that needs improvement in image data for a selected case that needs improvement. The model creation unit 3110 can obtain the data from the sampling unit 3109. A verification image 601 illustrated in FIG. 6A is one of the input images included in the verification data. An inference result 602 illustrated in FIG. 6B is a result of inference from the verification image 601 using the trained CNN, and illustrates an inference result for the Plant category. In addition, a region 603 indicates a region in which the output (score) of the inference result is low even though the ground truth (GT) of the recognition result is Plant, and such a region will be referred to as a region that needs improvement. A mask 604 illustrated in FIG. 6C is a mask for sampling the pixels of the region that needs improvement (region 603), and the pixels of a region 605 are to be sampled according to the mask 604. Here, input for specifying a masking portion on the verification image 601 is performed by the user, and a subject portion on the specified region is sampled.

As described above, the sampling unit 3109 can obtain information (the mask) indicating a region belonging to a specific domain in the input data for verification. Then, the sampling unit 3109 converts the verification image from an RGB image into an HSV image and obtains an HSV value on the mask. The user may specify a plurality of cases that need improvement, and when there are a plurality of cases that need improvement, the sampling unit 3109 may perform the processing for obtaining an HSV value for each of them.

The model creation unit 3110 may create a model for extracting a specific domain region from the feature amount in the region belonging to a specific domain in the input data. In this example, the model creation unit 3110 creates a specific domain model based on the HSV value thus obtained. In the present embodiment, it is assumed that the model creation unit 3110 models the HSV of the region that needs improvement with a trivariate normal distribution. The created specific domain model is stored in the model storage unit 3104.

The loss calculation unit 3107 may evaluate an error from at least one output of the intermediate layer using data (specific domain GT) indicating the ground truth for classification regarding each of the plurality of domains of the input data. For this, the model creation unit 3110 may create a plurality of models in accordance with the properties of regions that need improvement. For example, when of each the two or more regions of the same category that need improvement has a different characteristic, the model creation unit 3110 may create different specific domain models in accordance with the respective characteristics. This characteristic (property) can be arbitrarily set if the property affects detection; for example, when there is a region that needs improvement for grass under ambient light of a sunset and a backlit tree in regions of a Plant category, a region that needs improvement corresponding to each type can be collected. Then, a model (e.g., a trivariate normal distribution model of HSV) for each type (domain) may be created based on the features of a region that needs improvement corresponding to each type. In this example, it is assumed that the respective models are called “Sunset-Grass” and “Backlight-Tree”. The model creation unit 3110 may set weights based on the degree of importance for such a plurality of models and integrate them into a single mixed model. Hereinafter, the “mixed model” refers to such a model in which a plurality of models are integrated and is also included in the specific domain model of the present specification.

For the mixed model, the loss calculation unit 3107 can create a specific domain GT by the same processing as in step S4107. Here, the loss calculation unit 3107 can extract first and second domain regions from the input data. Further, the loss calculation unit 3107 can create, as a specific domain GT, a combination of data that indicates a ground truth for classification regarding input data in a first domain region and data that indicates a ground truth for classification regarding input data in a second domain region. For example, for the above-described mixed model of “Sunset-Grass” and “Backlight-Tree”, when the weights of integration are w1 and w2, respectively, the loss calculation unit 3107 can calculate the specific domain GTd of the mixed model using the following Equation (1).

GT_{d}=GT×(w1×(response of Sunset-Grass)+w2×(response of “Backlight-Tree”)) Equation (1)

Here, the GT is a value of an original GT of Plant, and the responses of “Sunset-Grass”/“Backlight-Tree” are responses of “Sunset-Grass”/“Backlight-Tree”models, respectively, for the HSV-converted image for training. A response of the model can be calculated using the Gaussian transformation as in the following Equation (2), where the HSV-converted image is hsv.

res=exp(−½(hsv−μ)^{T}Σ⁻¹(hsv−μ)) Equation (2)

Here, res is the response of the model, μis the average of the model, and Σis the variance-covariance matrix of the model. The calculated mixed model GTd is stored in the model storage unit 3104.

After the specific domain model is created in step S4104, the processing in step S4101 is performed again using the created specific domain model. In the updating processing in the second and subsequent steps S4104, the model creation unit 3110 may update the specific domain model or may use the same specific domain model without performing an update when it is assumed that the improvement for the case that needs improvement is insufficient. When there is a newly extracted case that needs improvement, the model creation unit 3110 may create a region that needs improvement (for example, a region corresponding to a flower in the shade) of a new type and a corresponding new model. In this case, the updating unit 3108 may perform the updating processing of step S4104 using a mixed model to which the new model has been added (integrated).

According to such a configuration, even when it is deemed that the recognition accuracy is unsatisfactory with respect to a specific case, it is possible to explicitly train the intermediate layer of the CNN for a target region having features similar to that case, and thereby improve the recognition accuracy.

As described above, the sampling unit 3109 presents a result of recognition with respect to the input data for verification, and the model creation unit 3110 can obtain information indicating a specific domain for which improvement of the recognition result in the input data for verification is required. According to such a configuration, training can be performed so as to optimize the machine learning model using the ground truth data for recognition with respect to the input data for training extracted for a specific domain. Accordingly, when it is deemed that the recognition accuracy is unsatisfactory with respect to a specific case, it is possible to explicitly train the machine learning model for the target region having a feature similar to this case, and therefore, it is expected that the recognition accuracy will be improved. Accordingly, this configuration in which training is performed using ground truth data for recognition with respect to input data for training extracted for a specific domain is not limited to training (e.g., training based on errors between the specific domain GT and the output of the intermediate layer) in the intermediate layer, and various training methods may be adopted.

In the present embodiment, a specific domain model is created by three variables (HSV). Improvement, especially in the recognition accuracy of specific colors, can be expected by this processing. The colors in the image data vary according to the colors of the subject and the colors of the light source as well as the surface characteristics of the subject, white balance, and the like. When it is desired to improve the recognition accuracy of a specific color, such as when recognition accuracy of grass with sunset as a light source is poor, for example, such training by HSV is particularly effective. However, it is not particularly necessary to perform each process in an HSV format, and processing according to the present embodiment may be performed in a desired format, such as, for example, performing processing using two variables (HS) or a different color space. In the present embodiment, the specific domain model has been described as being modeled with a multivariate normal distribution but may be modeled using, for example, Support Vector Machine (SVMs), a mixed normal distribution, an NN, or the like.

The learning apparatus 3100 according to the present embodiment can output, as an image, the output of a channel in which training by a specific domain GT is performed among the outputs of the intermediate layer of the CNN. For example, when the recognition accuracy of a region corresponding to a case that needs improvement in the final inference result is poor, it may be possible to output, as an image, the output of one channel being trained for the case that needs improvement and have the user confirm whether or not it is responding correctly. If the response is incorrect here, training is considered insufficient. Also, if the response is correct here, the network of an order lower than that intermediate layer is being correctly trained, and it is considered that it is necessary to improve a different channel or a network of a higher order. Thus, by visualization of the result of training of the intermediate layer, confirmation of the training state is possible, which may provide a clue towards the understanding the final inference result.

### APPLICATION EXAMPLE 1

The learning apparatus 3100 according to this embodiment performs training with respect to the output of the intermediate layer of the CNN by creating a GT in a specific domain in a positive case that needs improvement (hereinafter, simply a positive); however, it is possible to perform training in the same manner for a negative case that needs improvement (hereinafter, simply a negative). Here, it is assumed that a positive is a case in which a target cannot be detected by the CNN 203 even though a detection target is present, and a negative is a case in which a detection target has been erroneously detected by the CNN 203. For example, in a region where a GT is Sky or Other, if Plant is erroneously detected, the output of the intermediate layer can be trained so as to reduce erroneous detection. Thus, a region belonging to a specific domain may be at least one of a region in which a recognition target is present but is erroneously not recognized and a region in which a recognition target is not present but is erroneously recognized.

In the following, description is given for a method of improving a case that needs improvement related to such a negative while referencing step S4104 in FIG. 4B. Since other basic processing is performed in the same manner as in FIG. 4, redundant description will be omitted.

In step S4104, the model creation unit 3110 creates a specific domain model from a case that needs improvement. In this case, a negative is extracted as the case that needs improvement. That is, a negative has been selected from verification data by the user, and pixels in a region where a negative has been erroneously detected are sampled. This sampling processing is performed similarly to that for the region 605 illustrated in FIG. 6C. Here, among the regions that have been erroneously detected as Plant where the GT is not Plant or the regions that have been erroneously detected as Sky where the GT is not Sky, the pixels of a region for which it has been deemed improvement in recognition accuracy is necessary are sampled.

The following explanation is given assuming two specific domain models, a “negative type 1” and a “negative type 2”, have been created with Plant as the GT. The specific domain GT (¬GTd) of the negative of Plant can be calculated according to the following Equation (3).

¬GT_{d}=¬GT×(w3×(response of “negative type 1”)+w4×(response of “negative type 2”)) Equation (3)

Here, w3 and w4 are weights set to the negative type 1and the negative type 2, respectively, and ¬GT is a negative GT of Plant. The calculation of a specific domain model is performed in the same way as the processing in step S4107. By performing the loss computation processing of step S4109 using the specific domain model calculated in this way, it is possible to perform training for a negative with respect to the output of one channel of the intermediate layer.

### APPLICATION EXAMPLE 2

In this embodiment, with respect to the CNN model in which training is performed regarding verification data, processing of training is performed by additional training for the cases for which improvement in recognition accuracy is necessary. However, training using a specific domain model in the present embodiment is not limited to additional training. For example, image data indicating a case for which high-precision recognition is necessary may be set in advance by the user, and a specific domain model may be created by the model creation unit 3110 from a region that needs high precision (sampled in the same manner as the region that needs improvement) in that case. Thus, a specific domain may be a case for which high-precision recognition is necessary. Then, it is also possible to perform the initial training using a specific domain model.

FIG. 4D is a flowchart for explaining an example of processing for creating a specific domain model for a region that needs high precision as described above and then training the CNN. Since the processing and functional configuration at runtime using this CNN are basically the same, redundant description will be omitted.

The training processing described in FIG. 4D is performed in the same manner as the processing performed in FIG. 4B, except that step S4104, which is the process of creating a specific domain model, is performed immediately before step S4101. That is, the process proceeds to step S4101 after the specific domain model is first created based on a case that needs high precision. Then, when it is determined that there is a case that needs improvement in step S4103, the process returns to step S4104 and the process of step S4101 is performed again.

According to such processing, it becomes possible to set the case that needs high precision regarding the output of the intermediate layer at the beginning of training and train the CNN so as to improve the classification accuracy of that case.

### APPLICATION EXAMPLE 3

In the present embodiment, description is given assuming that the image recognition processing by semantic segmentation is performed, but the type of image recognition processing is not limited to that. For example, in place of semantic segmentation, the learning apparatus 3100 according to the present embodiment can perform an evaluation of the accuracy of image recognition by respectively setting appropriate evaluation indices using a known image classification technique or object detection technique and can perform training by a case that needs improvement (a case that needs high precision) in the same manner. When using the object detection technique, after a map of the final inference result 107 is outputted, post-processing such as regression of coordinates by a fully-connected layer or Non-Maximum Suppression is performed. Even in this case, the process of performing additional training on a specific domain based on a case that needs improvement selected from the verification data on a predetermined channel of the intermediate layer can be similarly performed. Therefore, even if different recognition tasks are used, when the recognition accuracy is deemed unsatisfactory for a specific case, the recognition accuracy can be improved by explicitly training for a case that needs improvement at the output of the intermediate layer of the CNN

### SECOND EMBODIMENT

In the first embodiment, regarding a case that needs improvement for which the user has determined that the accuracy of recognition for a specific color is low due to the influence of the color or the like of the light source, the classification accuracy is improved by creating one channel that responds to a region indicating that specific color and then performing training. Meanwhile, in the present embodiment, by training for the case that needs improvement using a plurality of channels of the intermediate layer, training is performed such that the output of those channels responds to a plurality of categories. In the following, a case where a case that needs improvement can be classified by color and other elements is assumed and it is assumed that training is performed such that a plurality of channels of the intermediate layer respond to a plurality of categories in the case that needs improvement.

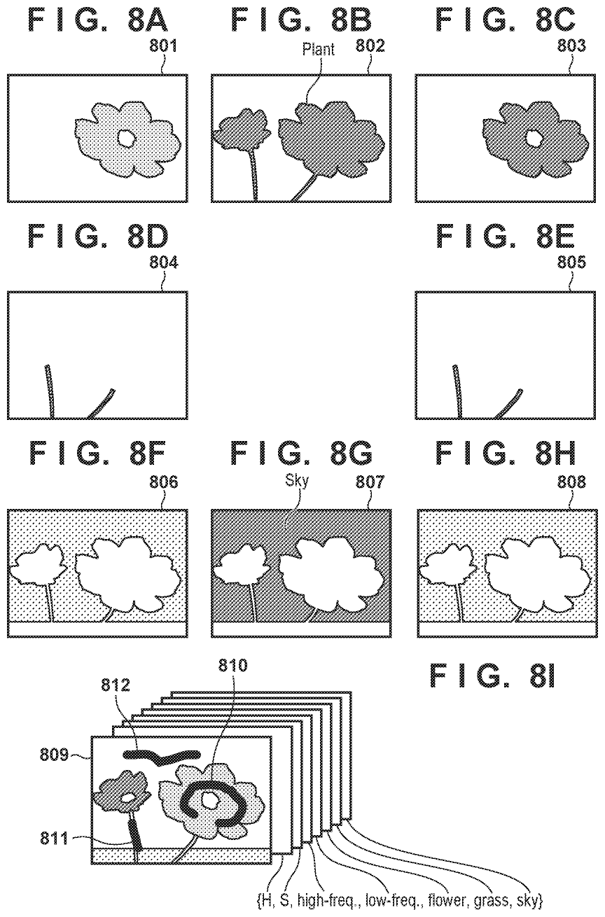

The model creation unit 3110 according to the first embodiment creates a specific domain model based on the HSV values of an image assuming a case that needs improvement in which the recognition accuracy is lowered due to having a specific color, such as “Sunset-Grass” or “Backlight-Tree”. A model creation unit 7004 (to be described later) according to the present embodiment creates a specific domain model based on elements in input data, such as color (HSV), an image characteristic such as spatial frequency, or a region category to be classified into, as a specific domain. The details of this processing will be described later with reference to FIGS. 8A to 8I.

The image recognition processing performed by the CNN according to the present embodiment is performed using basically the same network configuration as that illustrated in FIG. 1C. Further, the learning mechanism of the CNN according to the present embodiment is basically the same as that illustrated in FIG. 2. Regarding these, descriptions overlapping with the first embodiment will be omitted.

FIG. 7 is a block diagram illustrating an example of a functional configuration of a learning apparatus 7000 serving as an information processing apparatus according to the present embodiment. The recognition apparatus 3000 as the information processing apparatus according to the present embodiment has the same configuration as that illustrated in FIG. 3A of the first embodiment and performs the processing indicated in FIG. 4A during runtime. The learning apparatus 7000 has the same configuration as the learning apparatus 3100 except that it includes an NN learning unit 7100 having a region recognition unit 7001 and a loss calculation unit 7002 instead of the region recognition unit 3106 and the loss calculation unit 3107, a contribution calculation unit 7003, and a model creation unit 7004. Further, although the processing performed by the learning apparatus 7000 is basically the same as that indicated in FIGS. 4B and 4C, the difference between this processing and the processing in the first embodiment will be described below. In the present embodiment, three specific domain models corresponding to each of “petal”, “stem”, and “sky” regions are created (step S4104), and training for the domains corresponding to the respective models is performed in three channels of the intermediate layer. Here, it is assumed that the region of a flower in the first embodiment is divided into “petal” and “stem”, and then a specific domain model is created for each of them (corresponding GTs are both Plant).

In step S4101, the NN learning unit 7100 trains the CNN. In the present embodiment, in the training processing of the CNN indicated in FIG. 4C, each process excluding steps S4107 and S4109 is performed in the same manner as in the first embodiment.

In step S4107, according to the present embodiment, the loss calculation unit 3107 creates a specific domain GT using the stored specific domain model and GT. Here, the loss calculation unit 3107 respectively creates a specific domain GT based on the three specific domain models. FIGS. 8A to 81 are schematic diagrams for explaining specific domain GTs created in step S4107 according to the present embodiment.

The model creation unit 7004 creates a specific domain model. The specific domain model according to the present embodiment outputs a response representing a region having a specific color, a specific spatial frequency, and a specific category, such as a response 801 of FIG. 8A, for an input image.

The response 801 is a response of a first specific domain model, which corresponds to a category of “petal”, for the image obtained in step S4106. In FIG. 8A, the region of the mesh pattern of the response 801 corresponds to a region belonging to a specific domain (e.g., having a specific color, frequency, or category) in the input image, and here, it corresponds to a region belonging to the category of “petal”.

A Plant GT 802 is ground truth data corresponding to a Plant region of an image. Also, a specific domain GT 803 is a two-dimensional array obtained by multiplying the response 801 and the Plant GT 802 for each element of a pixel.

A response 804 is a response of a second specific domain model, which corresponds to a category of “stem”, for the image obtained in step S4106. Also, a specific domain GT 805 is a two-dimensional array obtained by multiplying the response 804 and the Plant GT 802 for each element of a pixel. That is, the specific domain GTs 803 and 805 are GTs for training for a region that needs improvement with respect to Plant.

In addition, a response 806 is a response of a third specific domain model, which corresponds to a category of “sky”, for the image obtained in step S4106. A Sky GT 807 is ground truth data corresponding to a Sky region of an image. A specific domain GT 808 is a two-dimensional array obtained by multiplying the response 806 and the Sky GT 807 for each pixel element. That is, the specific domain GT 808 is a GT for training for a region that needs improvement with respect to Sky. In the present embodiment, each of the elements of the respective responses, GTs, and specific domain GTs illustrated in FIGS. 8A to 8I are represented by real numbers of [0, 1].

In step S4109 according to the present embodiment, the loss calculation unit 7002 calculates the loss based on a predetermined loss function from an output of forward propagation, which is the target of training of the CNN 203, and a GT corresponding thereto by the same process as the loss calculation unit 3107 of the first embodiment. The loss calculation unit 7002 uses, as outputs of forward propagation, the output 210 of the intermediate layer 205 (here, three channels corresponding to petal, stem, and sky) and the output 202 of the final network (three channels). The GT corresponding to the output 202 is a specific domain GT (three channels of 803, 805, and 808), and the GT corresponding to the output 210 is a GT of each category (three channels of Plant, Sky, and Other in FIG. 1B). Similarly to the loss calculation unit 3107 of the first embodiment, the loss calculation unit 7002 respectively calculates a cross entropy loss from the pair of this output and GT and adds the calculated two cross entropy losses together with appropriate weighting.

In step S4102 according to the present embodiment, the NN learning unit 7100 evaluates the accuracy of the CNN model that has been trained in step S4101 in the same manner as in the first embodiment. Here, the contribution calculation unit 7003 calculates and evaluates a contribution to the final output for each channel of the intermediate layer.

As described above, in the present embodiment, by training for the case that needs improvement using a plurality of channels of the intermediate layer, training is performed such that the output of those channels responds to a plurality of categories. Here, the contribution calculation unit 7003 evaluates a contribution to the final output of the machine learning model for each channel of the intermediate layer. Then, the contribution calculation unit 7003 selects a channel used for training of the machine learning model from a plurality of channels of the intermediate layer based on the contribution. In this example, channels of a predetermined number (3 in the following example) are selected as channels to be used for training for the case that needs improvement in order of low contribution.

Hereinafter, an example of a method in which the contribution calculation unit 7003 calculates the contribution will be described. For example, the contribution calculation unit 7003 can evaluate the magnitude of the contribution of a channel by calculating the final output 202 when one channel of the intermediate layer is forcibly zeroed in the course of forward propagation and compares it with the normal output 202 that is not zeroed. That is, the contribution calculation unit 7003 evaluates the contribution of an intermediate layer channel to be larger, the larger the amount of change in the response (score) of the final output between a case where a certain intermediate layer channel is zeroed and the case where it is not zeroed. The contribution calculation unit 7003 can evaluate the change amount of the above-described score using an appropriate measure, such as a sum of absolute differences of the values for each pixel. Hereinafter, it is assumed that the contribution of a channel is determined according to the cumulative value of the amount of change that has been calculated and accumulated over all of the verification data to be used between a case where that channel is zeroed and a case where it is not zeroed.

Here, the contribution calculation unit 7003 selects, from the channels of the intermediate layer, a channel whose contribution to the final output is low. For example, for each channel of the intermediate layer, the contribution calculation unit 7003 can calculate the contribution to the final output using all of the verification data and obtain, as a channel having a lower contribution, a numeral of the desired number of channels in order from the channel having the smallest contribution. Further, the contribution calculation unit 7003 need not use all of the verification data and may perform a process of calculating the contribution by calculating the cumulative value of the change amount of the score by limiting to a case that needs improvement, which is a subset of the verification data, and then selecting a desired number of channels as having a lower contribution similarly in order from the smallest contribution. Further, the contribution calculation unit 7003 can select a channel having a lower contribution using both the contribution calculated using the entire verification data and the contribution calculated by limiting to a case that needs improvement (for example, selecting one that is assumed to have a lower contribution in both). Here, three channels are selected in order from the lowest contribution. The process of selecting the channels performed by the contribution calculation unit 7003 may be executed only at the first loop processing indicated in FIG. 4B.

The evaluation of the contribution is not particularly limited to the above-described method as long as the influence on the final output by that channel can be measured. For example, the contribution calculation unit 7003 may accumulate the output for each channel of the intermediate layer for when inputting the verification data over all the verification data and, in accordance with the cumulative value, perform evaluation of the contribution of the channel. Here, for example, it is assumed that the lower the cumulative value described above, the lower the contribution, and the channels of a desired number are selected as those with lower contribution in order from the lowest cumulative value.

In step S4104 according to the present embodiment, the model creation unit 7004 creates a plurality of specific domain models based on a region that needs improvement that is set in the same manner as in the first embodiment. Here, the model creation unit 7004 creates three specific domain models corresponding to “petal”, “stem”, and “sky”, respectively, which output the responses 801, 804, and 806 of FIGS. 8A, 8D, and 8F. In this embodiment, values in the HSV color space, spatial frequencies, and region categories are used as the image characteristics as described above. Here, the model creation unit 7004 creates a model based on a total of seven dimensions of a region that needs improvement: an H value and an S value, a high-frequency value and a low-frequency value with respect to spatial frequency, and a likelihood of petal, a likelihood of stem, and a likelihood of sky with respect to the region categories.

FIG. 8I is a schematic diagram for explaining a process of sampling pixels from a case that needs improvement. The model creation unit 7004 creates an image (map) of seven channels, H, S, high frequency, low frequency, petal, stem, and sky, as illustrated in FIG. 81 from a verification image 809. In this case, masks 810 to 812 for sampling pixels in regions that need improvement are set, and pixels on the regions specified by the masks are respectively sampled. The mask processing is performed similarly to the first embodiment for each category. Of these, the H and S values are calculated by HSV conversion of the RGB image (verification image 809). The high frequency and the low frequency (High-freq., Low-freq.) are maps created by, for example, discrete cosine transforming a brightness image in 8×8 blocks, halving 64 bases into 32 pieces of high frequency and low frequency, and accumulating 32 maps, respectively. If the size of a created map is different from the verification image 809, it may be resized to the same size as the verification image 809. It is assumed that the map (Flower, Grass, and Sky) of a specific category (petal, stem, and sky) is manually created in advance from the verification data as a GT, but the present invention is not particularly limited to this. For example, by using the techniques described in Hengshuang Zhao, Jianping Shi, Xiaojuan, Xiaogang Wang, Jiaya Jia, “Pyramid Scene Parsing Network”, CVPR 2017, 2016, a map of each category may be provided utilizing the inference result of semantic segmentation by a large-scale CNN with detailed region categories.

Also in step S4107, which is a process during training of the CNN, the training image is converted into 7 channels in the same manner as a specific domain model and then inputted to the specific domain model, and the response to the specific domain model is obtained.

In the present embodiment, it is assumed that the model creation unit 7004 creates a map of seven channels as described above, but the elements of each channel are not limited to what has been described above, and the number of channels is also not limited to seven. In addition, a plurality of specific domain models are used in the present embodiment, and some or all of them may be a mixed model.

According to such processing, even in cases where a plurality of categories need improvement, it becomes possible to perform training for cases that need improvement using a plurality of channels of an intermediate layer of a CNN. In addition, by using not only a specific color but also a spatial frequency and a category as specific domains, a region that needs improvement can be modeled in more detail than in the first embodiment, and improvements for more particular cases that need improvement can be made.

### THIRD EMBODIMENT

In the second embodiment, improvement has been realized for cases that need improvement of a plurality of categories by classifying cases that need improvement in the verification data into a plurality of types and then creating a specific domain model for each of the plurality of types. It is not difficult to perform the operation of mixing specific domain models of a case that needs improvement of a single category or the operation of creating a specific domain model by dividing a single category based on human intuition or experience. Meanwhile, when there are various cases to be improved or a large number of categories, it is difficult to perform the above-described mixing and dividing operations by user operation based on intuition or experience. For example, it is often difficult to make an appropriate choice for a specific domain model on which of the other models to mix with, which GT corresponds as a ground truth, which channel to assign, or the like.

From this viewpoint, the learning apparatus according to the present embodiment first creates a specific domain model for a single category by the same processing as in the first embodiment according to the output of the intermediate layer of the CNN. The learning apparatus then performs, for the created specific domain model, an automatic search on which of the other models to mix with, which GT corresponds as a ground truth, which channel of the intermediate layer to assign, or the like so that the classification accuracy of the verification data is maximized. Hereinafter, it is assumed that these correspondence relationships to be searched are collectively referred to as assignment of specific domain models.

The basic processing at the time of inference and training of the CNN provided by the learning apparatus according to the present embodiment is the same as the processing in the first embodiment. That is, since the processing illustrated in FIGS. 1C and 2 is similarly performed in the present embodiment, redundant description will be omitted.

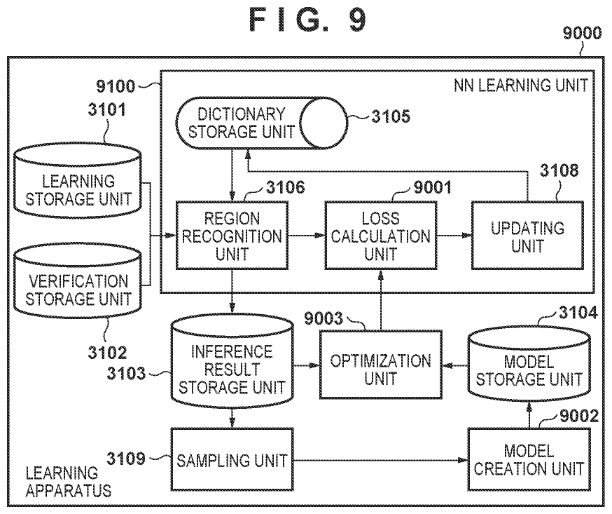

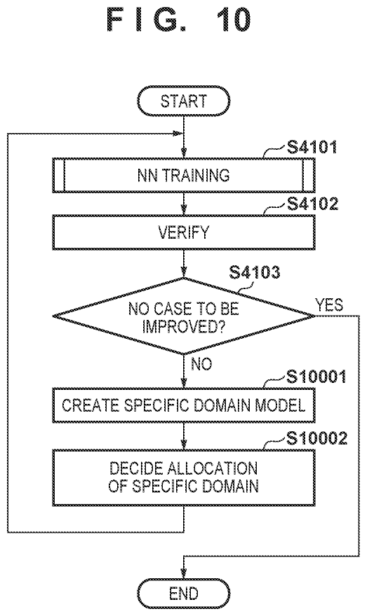

FIG. 9 is a block diagram illustrating an example of a functional configuration of a learning apparatus 9000 serving as an information processing apparatus according to the present embodiment. The recognition apparatus 3000 has the same configuration as illustrated in FIG. 3A of the first embodiment and performs the processing indicated in FIG. 4A during runtime. The learning apparatus 9000 has the same configuration as the learning apparatus 3100 except that it comprises an NN learning unit 9100 having a loss calculation unit 9001 instead of the loss calculation unit 3107 and a model creation unit 9002 instead of the model creation unit 3110 and newly comprises an optimization unit 9003.

FIG. 10 is a flowchart illustrating an example of the training processing performed by the learning apparatus 9000. Further, although the process in step S4101 is basically the same as that indicated in FIG. 4C of the first embodiment, the difference from the process of FIG. 4C will also be described below.

The processing of steps S4102 and S4103 is performed in the same manner as in the first embodiment. In step S10001, the model creation unit 9002 creates a plurality of specific domain models from a case that needs improvement. The process of creating the specific domain models is performed in the same manner as in step S4104 of the first embodiment, but the creation of a mixed model is not performed here, and it is assumed that a plurality of specific domain models corresponding to a single category is created. In the present embodiment, the loop processing from steps S4001 to S10002 is repeatedly performed; however, it is assumed that the processing of step S10001 is performed only for the first time and is omitted in the second and subsequent loop processing. The created specific domain models may also be divided into a plurality of specific domain models (e.g., so as to divide the models corresponding to a Plant region into “petal” and “stem”) and used for subsequent processing.

In step S10002, the optimization unit 9003 may determine a combination of at least one intermediate layer of the machine learning model and at least one of a specific domain and a specific class. Here, a specific class (e.g., Plant) is referred to from ground truth data (e.g., Plant GT) indicating whether each element of the input data belongs to a specific class to create data (specific domain GT) indicating the ground truth of the classification for a specific domain of the input data. In the present embodiment, the optimization unit 9003, for a specific domain model, performs an automatic search on which specific domain model to mix with, which GT corresponds as a ground truth, or which channel of the intermediate layer to assign.

The optimization unit 9003 according to the present embodiment performs an automatic search by reinforcement learning and can search for an assignment of a specific domain model, which has a high recognition accuracy for verification data including a case that needs improvement, according to that verification data using the accuracy for verification data as a reward. The optimization unit 9003 can perform an automatic search in accordance with a method of Barret Zoph, Quoc V. Le, “Neural Architecture Search with Reinforcement Learning” ICLR 2017, 2016, which discloses a method of automatically searching an optimal network structure of a CNN or an LSTM (Long short-term memory), for example, by a framework of reinforcement learning. Here, an RNN (Recurrent Neural Network) which determines the structure of a network is used as a controller for inputting and outputting data. In the present embodiment, the controller of the RNN may output the mixed weights of the specific domain models for each channel of the intermediate layer and a GT to be multiplied for creating the specific domain GT.

In the present embodiment, the controller of the RNN performs training of the machine learning model by reinforcement learning so that the accuracy corresponding to at least one of the recognition accuracy for the input data for verification and the recognition accuracy for a specific domain in the input data for verification is maximized. Here, for example, the following Equation (4), which uses the weighted sum of the two precisions, the accuracy for all of the verification data and the accuracy for a case that needs improvement which is a subset of the verification data, is used as a reward for reinforcement learning.

R=w1×Acc^{A}×w2×Acc^{S} Equation (4)

Here, R is the reward used in the automatic search by reinforcement learning, and AccA and AccS are the accuracy for all of the verification data and the accuracy for the case that needs improvement, respectively, and w1 and w2 are their respective weights. These weights are set to arbitrary values in advance.

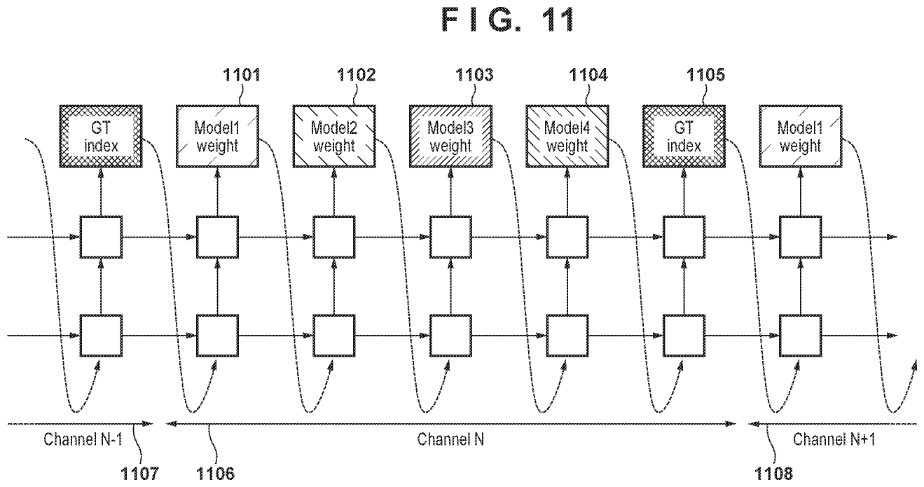

FIG. 11 is a diagram for explaining the output of the controller of the RNN. In the example of FIG. 11, there are four specific domain models corresponding to a single category: Model 1, Model 2, Model 3, and Model 4. Here, for each channel of the intermediate layer, the allocation of the specific domain models is determined by outputting the mixed weights of each specific domain model and the GT multiplied for creating the specific domain GT.

Processes 1101 to 1104 are processes for outputting a mixed weight of each of Model 1 to Model 4 in a channel N of the intermediate layer. A process 1105 is a process of outputting an index of GT to be multiplied in the channel N. In this case, index=1 indicates Plant, index=2 indicates Sky, index=3 indicates Other, and index=0 indicates that no GT is multiplied. The output of the processes included in a range 1106 is the output with respect to the channel N, the output with respect to channel N−1 is collected before that, and the output with respect to channel N+1 is collected after that. Here, it is assumed that the channels whose mixed weights to be output are all zero function in the same manner as the channels of the intermediate layer of an ordinary CNN that does not learn using teacher data.

By updating the RNN controller with the output as illustrated in FIG. 11 by the reward indicated in Equation (4), an optimal allocation of a specific domain model whose classification accuracy is good for all of the verification data and classification accuracy for a case that needs improvement is also high is searched for. This process is performed for each step S10002 in the loop processing of FIG. 10. The CNN training processing is performed in step S4101 of the next loop in accordance with the allocation of specific domain models updated here. That is, the loss calculation unit 9001 can evaluate the error between the specific domain GT and at least one output of the intermediate layer in accordance with the above assignment.

According to such processing, how to allocate the created specific domain models can be searched using reinforcement learning so as to maximize accuracy of classifying verification data. Therefore, the recognition accuracy can be improved even when it is difficult to allocate a specific domain model by user operation, such as when the number of GT channels is large or the number of types of cases that need improvement is large.

### FOURTH EMBODIMENT

In the above-described embodiment, each processing unit illustrated in FIG. 3 or the like may be realized by dedicated hardware, for example. Alternatively, some or all of the processing units of the recognition apparatus (e.g., 3000) and the learning apparatus (e.g., 3100) may be implemented by a computer. In the present embodiment, at least some of the processing according to each embodiment described above is executed by a computer.

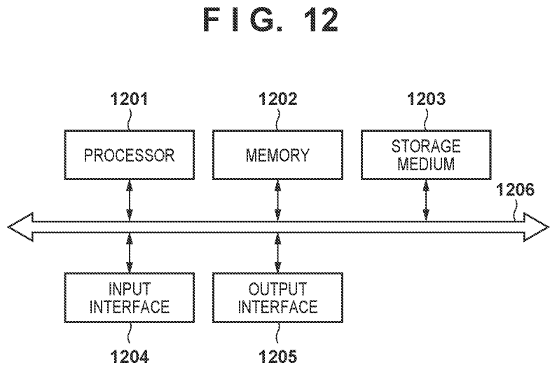

FIG. 12 is a diagram illustrating a basic configuration of a computer. In FIG. 12, a processor 1201 is, for example, a CPU and controls the operation of the entire computer. A memory 1202 is, for example, a RAM and temporarily stores programs, data, and the like. A computer-readable storage medium 1203 is, for example, a hard disk, a CD-ROM, or the like and stores programs, data, and the like for a long period of time. In the present embodiment, a program for realizing the functions of each unit stored in the storage medium 1203 is read out to the memory 1202. The processor 1201 realizes the functions of each unit by operating in accordance with a program on the memory 1202.

In FIG. 12, an input interface 1204 is an interface for obtaining information from an external apparatus. In addition, an output interface 1205 is an interface for outputting information to an external apparatus. A bus 1206 connects each of the above-described units and allows data to be exchanged.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-082595, filed May 14, 2021, which is hereby incorporated by reference herein in its entirety.

What is claimed is:

1. An information processing apparatus operable to train a machine learning model that has a hierarchical structure configured by a plurality of hierarchical layers and that is used for recognizing a recognition target in inputted data, the apparatus comprising:
an obtaining unit configured to obtain input data and data indicating a ground truth of an output from the machine learning model regarding the input data; and
a learning unit configured to train the machine learning model based on an error between the data indicating the ground truth of the output from the machine learning model regarding a specific domain of the input data and at least one output in an intermediate layer of the machine learning model with respect to the input data.

2. The information processing apparatus according to claim 1, further comprising: an extraction unit configured to extract the specific domain region from the input data.

3. The information processing apparatus according to claim 2, further comprising: a first creation unit configured to create the data indicating the ground truth regarding the specific domain of input data from the data indicating the ground truth of the output from the machine learning model regarding the input data in the specific domain region.

4. The information processing apparatus according to claim 3, wherein the first creation unit creates data indicating the ground truth regarding the specific domain of the input data from ground truth data indicating whether or not each element of the input data in the specific domain region belongs to a specific class.

5. The information processing apparatus according to claim 2, wherein
the extraction unit extracts first and second domain regions from the input data, and
the data indicating the ground truth regarding the specific domain of the input data is a combination of data indicating a ground truth of an output from the machine learning model regarding the input data in the first domain region and data indicating a ground truth of an output from the machine learning model regarding the input data in the second domain region.

6. The information processing apparatus according to claim 1, further comprising:
a recognition unit configured to recognize a recognition target in input data for verification using the machine learning model; and
a designation obtaining unit configured to obtain information indicating the specific domain for which a recognition result needs to be improved in the input data for verification, wherein
the learning unit performs additional training for the machine learning model in accordance with the information indicating the specific domain.

7. The information processing apparatus according to claim 6, wherein the designation obtaining unit obtains information indicating a region belonging to the specific domain in the input data for verification.

8. The information processing apparatus according to claim 1, further comprising: a second creation unit configured to create a model that extracts the specific domain region from a feature amount in a region belonging to the specific domain in the input data.

9. The information processing apparatus according to claim 7, wherein the region belonging to the specific domain is at least one of a region in which a recognition target is present but is erroneously not recognized and a region in which a recognition target is not present but is erroneously recognized.

10. The information processing apparatus according to claim 1, further comprising:
a first evaluation unit configured to evaluate a degree of a contribution to a final output of the machine learning model for each channel of the intermediate layer; and
a selection unit configured to select a channel to be used for training of a machine learning model by the learning unit from a plurality of channels of the intermediate layer based on the contribution.

11. The information processing apparatus according to claim 1, wherein the learning unit trains the machine learning model by reinforcement learning so as to maximize an accuracy for at least one of a recognition accuracy for input data for verification and a recognition accuracy for a specific domain in the input data for verification.

12. The information processing apparatus according to claim 1, wherein
the learning unit decides a combination of:
at least one intermediate layer of the machine learning model, and
at least one of the specific domain and a specific class, and
the specific class is referenced to create the data indicating the ground truth regarding the specific domain of the input data from ground truth data indicating whether or not each element of the input data belongs to the specific class.

13. An information processing apparatus, comprising:
an obtaining unit configured to obtain input data; and
a recognition unit configured to recognize a recognition target in the input data using a machine learning model having a hierarchical structure configured by a plurality of layers, wherein
the machine learning model is trained, using data indicating a ground truth of an output from the machine learning model with respect to input data for training that has been extracted for a specific domain, so as to optimize at least one output of an intermediate layer of the machine learning model for input data.

14. The information processing apparatus according to claim 1, wherein the specific domain is a portion having a specific color, a portion having a specific spatial frequency, or a portion of a subject of a specific class.

15. The information processing apparatus according to claim 1, wherein the specific domain is a case for which it is necessary to perform recognition at a higher accuracy.

16. The information processing apparatus according to claim 1, wherein the machine learning model classifies a sub-region in input data into a category, detects a recognition target that is present in input data, or classifies input data.

17. An information processing apparatus operable to train a machine learning model that has a hierarchical structure configured by a plurality of hierarchical layers and that is used for recognizing a recognition target in inputted data, the apparatus comprising:
a recognition unit configured to recognize the recognition target in input data using a machine learning model having a hierarchical structure configured by a plurality of layers;
a presentation unit configured to present a result of recognition by the recognition unit with respect to input data for verification;
an obtaining unit configured to obtain information indicating a specific domain for which a recognition result needs to be improved in the input data for verification; and
a learning unit configured to perform training so as to optimize the machine learning model using data indicating a ground truth of an output from the machine learning model with respect to input data for training extracted regarding the specific domain.

18. An information processing method performed by an information processing apparatus operable to train a machine learning model that has a hierarchical structure configured by a plurality of hierarchical layers and that is used for recognizing a recognition target in inputted data, the method comprising:
obtain input data and data indicating a ground truth of an output from the machine learning model regarding the input data; and
train the machine learning model based on an error between the data indicating the ground truth of the output from the machine learning model regarding a specific domain of the input data and at least one output in an intermediate layer of the machine learning model with respect to the input data.

19. An information processing method performed by an information processing apparatus operable to train a machine learning model that has a hierarchical structure configured by a plurality of hierarchical layers and that is used for recognizing a recognition target in inputted data, the method comprising:
recognize the recognition target in input data using a machine learning model having a hierarchical structure configured by a plurality of layers;
present a result of recognition with respect to input data for verification;
obtain information indicating a specific domain for which a recognition result needs to be improved in the input data for verification; and
perform training so as to optimize the machine learning model using data indicating a ground truth of an output from the machine learning model with respect to input data for training extracted regarding the specific domain.

20. A non-transitory computer readable storage medium on which is stored a computer program for making a computer execute an information processing method for an information processing apparatus operable to train a machine learning model that has a hierarchical structure configured by a plurality of hierarchical layers and that is used for recognizing a recognition target in inputted data, the method comprising:
obtain input data and data indicating a ground truth of an output from the machine learning model regarding the input data; and
train the machine learning model based on an error between the data indicating the ground truth of the output from the machine learning model regarding a specific domain of the input data and at least one output in an intermediate layer of the machine learning model with respect to the input data.
